(19) United States
(12) Patent Application Publication
(10) Pub. No.: US 2015/0154584 A1
(43) Pub. Date: Jun. 4, 2015

(54) SYSTEM TO ENABLE ELECTRONIC PAYMENTS WITH MOBILE TELEPHONES WITHOUT RISK OF ANY FRAUD

(71) Applicants: K. Ramakrishna Prashant, Chennai (IN); Ramkrishna Jairam Iyer, Chennai (IN)

(72) Inventors: K. Ramakrishna Prashant, Chennai (IN); Ramkrishna Jairam Iyer, Chennai (IN)

(21) Appl. No.: 14/508,659

(22) Filed: Oct. 7, 2014

(30) Foreign Application Priority Data
Dec. 3, 2013 (IN) 5569/CHE/2013

(51) Int. Cl. G06Q 20/32; G06Q 20/24; G06Q 20/26; G06Q 20/40

(52) U.S. Cl. CPC G06Q 20/322; G06Q 20/40; G06Q 20/24; G06Q 20/26

(57) ABSTRACT

The invention described herein is a process realized though a set of apparatuses that ensure electronic payment transactions initiated over point-of-sale counters, web retailing and ATMs remain free of fraud. The invention is devised in a manner that electronic transactions are conducted through the use of a smart mobile station and does not involve the use of plastic cards with magnetic strips/embedded chips that are in vogue today. Each transaction initiated by a merchant or user is identified by the user's mobile number and does not carry any sensitive information about the merchant or the user over public networks. The electronic transactions initiated and processed with the said invention are completed within the bank or financial institution's network, thereby precluding the role Credit Card Associations reducing transaction cost as well as providing aforementioned security and privacy. The fool-proof electronic security certificates issued by the bank or financial institution are used to uniquely identify both users and merchants, and are the sole means of authentication and authorization. The said invention protects users from eventualities such as loss or cloning of the mobile stations through a hardened security mechanism; and protects the bank or financial institution from receiving unauthorized transactions.

### PREAMBLE

The following complete specification particularly describes an invention and the method of performing the invention that is related to electronic transactions between a consumer/client and a retailer/services provider. Said electronic transaction system is operable using a mobile smart phone device wherein a transaction is identified by the mobile phone number of the customer/client. The invention makes extinct the use of credit/debit card with their attenuating issues related to fraud by way of rampant data theft, thereby making the electronic transaction safe to consumers. The robustness of the said electronic payment device is enhanced by the individualized security parameters built into the device at various levels. The security system keeps a check on handlers of the system both from the consumer/client side as well as the merchant end and is programmed to be disabled upon a perceived breach. This novel electronic payment system is implementable by consumers and vendors for point-of-sale transactions, web based transactions and even for transactions made through ATM machines without the need to divulge any classified personal information that would make the individual susceptible to fraudulent elements.

### PRIOR ART AND PROBLEM TO BE SOLVED

Electronic payment systems are at the forefront of commerce today because of the ease they bring into transacting business for all involved parties—merchants, consumers and Financial Institutions. A variety of electronic payment systems exist and new ideas mushrooming by the day.

Credit cards, debit cards and prepaid cards currently represent the most common form of electronic payments. For all 3 types of cards the consumer or the business most often uses a plastic card, commonly with a magnetic stripe. Cards are subject to a variety of fraudulent practices and theft of card data exposes card holders to losses and inconveniences.

Online payments are also increasingly playing a greater role in fund transfer. This mode of electronic payment involves the customer transferring money or making a purchase online via the internet. Consumers and businesses can transfer money to third parties from the bank or other account, and they can also use credit, debit and prepaid cards to make purchases online. ‘Card-not-present’ scenarios increase the threat of fraud compelling Banks, Financial Institutions and Card Associations to impose additional vigilance which increases the operational costs.

Television Set-Top Boxes and Satellite Receiver have been used in electronic transactions through specialized boxes attached to a television. The set-top box attaches to the television and a keyboard or other device, and customers can make purchases by viewing items on the television. Payment is made electronically using a credit card or other account. While usage is presently low, it could grow substantially in countries with a strong cable or satellite television network.

Electronic Payments Networks of various countries have systems wherein the consumer can go online, to a financial service kiosk or use other front-end devices to access their account and make payments to businesses or other individuals.

Companies and service providers in several countries have set up Financial service kiosks to enable financial and non-financial transactions. These kiosks are fixed stations with phone connections where the customer usually uses a keyboard and television-like screen to transaction or to access information.

Mobile computing devices such as smart phones, tablets, PDAs are currently the latest gadgets deployed into the electronic transaction segment. Smart phones have been used in a variety of ways to help in financial transactions. For instance, US patent application 20110039585 by Rouse, Alan et al discloses a embodiments that support purchase transactions between a buyer and a seller, each using a cell phone for the transaction. Rose; Gregory Gordon; et al in their US application 20130013433 disclose an invention wherein a mobile wireless device is used has location determinants that serve for security during an electronic transaction. US application number 20120209732 also discloses a method of using a card based electronic payment through the use of a mobile station. US patent application 20060224470 has a server that communicates to the mobile phone and point of sale devices that may come in many forms such as an electronic cash register. The server connects with all such devices and effects payments. Here the POS device may also be the sellers' mobile phone. Such an invention will be construed as the same or substantially the same invention as the server mediates the transaction between mobile phones. Embodiments disclosed in US applications 20120303528, 20120095856 also show method(s) of electronic transaction using a mobile computing device. US application 20110143711 by Ron et al discloses systems and method to improve security of payment transactions via mobile communications. A phone number is used to tag transactions, communication through server and transaction effected through the server. The authorization is done via two identification procedures successively. Fraud or the lack of it ascertained through the difference in the distance between the first communication and the second. US application 20090204546 provides a financial transaction processing system which combines the facilities of mobile phone systems using SMS with existing payment clearance systems.

In all the aforementioned types of electronic transactions using a mobile computing device or otherwise, the customer/client using the system are vulnerable because the systems basically use credit card/debit card numbers for processing the transactions. This exposes card holder details to the public domain and increases the risk of fraud during an electronic transaction. The security measures that have been developed around these electronic transactions are not personalized enough to provide individualized security the stake holders in a transaction. The system still relies on authentication of users by Credit Card Associations, thereby incurring the fee for service that is usually passed on to the merchant or customer.

Customers need to have foolproof security for electronic transactions (even in the event of theft of the device), merchants using the device need to be authenticated in order to prevent fraud and more importantly banks need a system of authentication understood by them that would cut their transaction expenses. The aforementioned problems found in the current art have been addressed by the said invention. The inventive technology described in detail along with figures in the subsequent sections is intended to disclose a solution to these gaps in technology.

### OBJECTIVES OF THE INVENTION

The principle objective of the invention is to provide an electronic transaction system that uses a smart mobile device.

Another objective of the invention of the invention is to provide a completely card-free electronic transaction system that may be effected through a smart mobile device.

Another objective of the invention is to prevent personal data of users from entering the public domain thereby preventing data theft that leads to frauds during an electronic transaction. This is achieved by making viable transactions through the use of the mobile phone number to identify the payment transactions.

Another objective of the invention is to provide a digital security certificates for both the Users and the Merchant Organization representatives that are issued by the Bank or Financial Institution which would be used for authentication during every transaction.

Another important object of the invention is to make invalidate the role of Card Associations as intermediaries thereby substantially lowering transaction charges.

Another objective of the invention is to provide device security that would hinder access to personal data of the user even during the event of loss of the device.

Another vital objective of the invention is to enable financial transactions through this system from any geographical location.

### FIELD & USE OF INVENTION

This invention related to and particularly describes an electronic apparatus and system for electronic payment (typically replacing/enhancing the existing Credit/Debit card payment system) using smart mobile stations (smart mobile phones, tablets etc). The customers' mobile stations are installed with a software application which interacts with server applications hosted by the Bank or Financial Institution, over the Internet, to participate in the electronic payment process.

The said invention unifies a Bank or Financial Institution's Issuer business with the Bank or Financial Institution's Acquirer business. That is, it facilitates the Bank or Financial Institution to become the Acquirer for all Credit/Debit card accounts issued by the Bank or Financial Institution. By enabling this facility, the said invention does away with the need for the Bank or Financial Institution to interact with any Card Association System for validating a transaction initiated by a card issued by the Bank or Financial Institution. The transactions do not incur the part of the Interchange fee that the Card Association charges on a per transaction basis. This enabling feature of the invention would save money for the banks and ultimately the consumers who migrate to this technology.

The said invention also does away with a need to use magnetic strip or embedded chip enabled plastic cards that are ubiquitous today. By doing away with the need to use plastic cards, the said invention simultaneously removes the need to use the plethora of card swiping devices that merchants must use today, to initiate Credit/Debit card based payments along with brining a sense of security to card owners who do not have to part with their Credit/Debit card details while making payments. This eliminates risk of the Credit/Debit card data theft for the Credit/Debit card owner.

Merchants, be they point-of-sale counters/desks or e-commerce web sites or Bank or Financial Institution owned ATM machines, can participate in system with consummate ease—point-of-sale counters require an internet enabled browser while e-commerce websites and ATM Machines must interface with a web service. All information interchange occurs over Transport Layer Security (TLS) connections which ensure complete data privacy. The manner of construction and method of operating the device will become apparent to those skilled in the art when reading the detailed description and method of operating the invention that is given hereunder.

### STATEMENT OF THE INVENTION

Accordingly the invention provides an apparatus consisting of Merchant Agent Server (MAS), User Agent Server (UAS), Bank or Financial Institution Gateway Server (BGS) and Mobile Station User Application (MSUA), that collaborate with an intelligent software to enable electronic payments with smart mobile stations, without the risk of any fraud. The said apparatus and the process of operating the apparatus collectively leads to a fraud free electronic transaction system that is operable through a merchant point-of-sale terminal or for payments through the internet or while transacting at the ATM. The unique nature of the said system lies in its absolute independence from the traditional methods of electronic transaction that involve the use of credit and debit cards. The said system has unique security/identity elements that do not require verification/intervention by Credit Card Associations. This implies that there are no transaction charges to be paid and the personal information such as card numbers are not revealed to third parties. The security features include features that deactivate the system in cases of theft of the smart mobile device as well as individualized & authorized certifications presented to the bank by the user and the merchant involved in the transaction.

### DRAWINGS

In order to describe the manner in which the above-recited and other advantages and features can be obtained, a more particular description is provided below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary network topology that is typical of most credit/debit card transaction processing systems.

FIG. 2 illustrates an exemplary network topology for implementing the invention.

FIG. 3 shows an embodiment of a mobile station user application.

FIG. 4 shows an exemplary embodiment of a user agent server.

FIG. 5 illustrates an exemplary embodiment of a merchant agent server.

FIG. 6 illustrates an exemplary embodiment of a bank gateway server.

FIG. 7 shows an exemplary Purchase transaction flow in the MAS for the POS embodiment.

FIG. 8 shows a flow of an exemplary Purchase transaction flow in the UserApp and UAS.

FIG. 9 illustrates an exemplary Purchase transaction flow in the MAS after user endorsement.

FIG. 10 shows an exemplary approval of a Purchase transaction by the bank's Processor System within the bank's private network.

FIG. 11 shows an exemplary Purchase transaction flow for updating the merchant and the user after bank response is received.

### DESCRIPTION

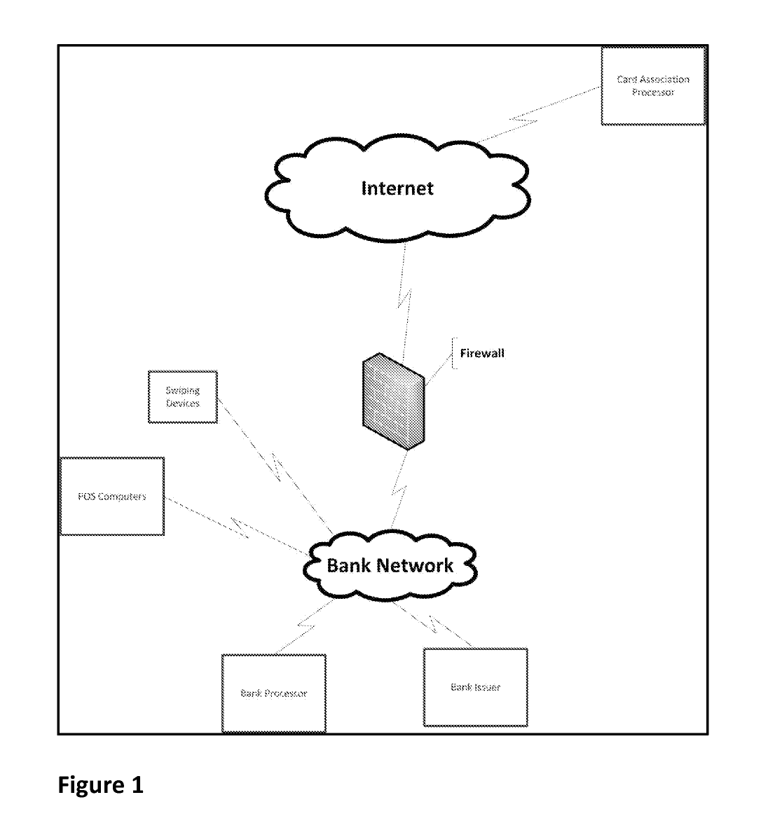

### FIG. 1

### Network Topology of Prevalent Electronic Payment Systems

The topology of a generic network that is typical of most Credit/Debit card transactions processing System is centered on the Card Association which acts as a mediator between the Credit/Debit card Issuer Bank or Financial Institution and the Merchant Acquirer Bank or Financial Institution. The following are the components of a typical Credit/Debit card processing system:

### Point-of-Sale Stations (POS)

POS stations are where all transactions are initiated. A card swiping device, in one of its several forms, is an essential part of the transaction process. The card swiping devices are supplied and maintained by the Merchant Acquirer Bank or Financial Institution. The swiping machines read the magnetic strip or the microchip on the Credit/Debit card and transfer the details along with the charge amount and Merchant details to the Merchant Acquirer bank or Financial Institution's Processor System.

### Acquirer Bank Processor System (ABPS)

The ABPS receives the transaction from the card swiping device and validates the information received. After successful validation, it sends the transaction details to the Card Association based on the first six digits of the Credit/Debit card number. It then waits for a response from the Card Association in order to complete the transaction with the card swiping device. For transactions that are approved by the Issuer Bank, the ABPS opens a credit line to the Merchant's account.

### Card Association System (CAS)

The CAS helps in locating the Credit/Debit card Issuer Bank System which can validate the Credit/Debit card information and available credit for the value of purchase made. It receives the response from the Issuer Bank and relays it to the ABPS.

### Issuer Bank System (IBS)

The IBS is the application that is run by the Bank or Financial Institution that issued the Credit/Debit card. The IBS validates the Credit/Debit card information received from the CAS, checks the revolving account for available credit/fund balance and approves/rejects the transaction.

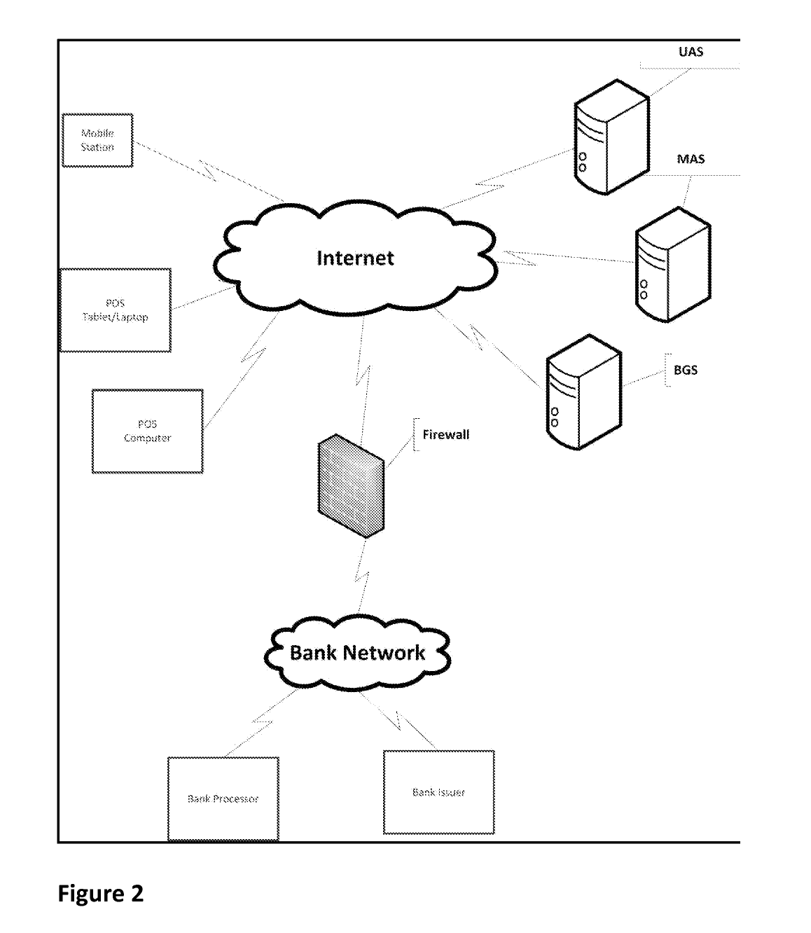

### FIG. 2

### Network Topology for Implementing the Said Invention

### Point-of-Sale Stations (POS)

With the said invention, POS stations do not require any kind of swiping devices; the Users do not have any plastics either. POS stations use an Internet browser in a personal computer, laptop or tablet (or similar computing devices) which has the electronic security certificate (similar to a X509 Certificate) issued by the Bank or Financial Institution.

After the Issuer Bank approves the transaction, the card swiping device prints out the transaction for the Credit/Debit card owner to sign. The Merchant POS agent is expected to verify the signature and must retain the transaction slip signed by the Credit/Debit card owner. The signed transaction slip is sent to the Acquirer Bank for verification after which the Acquirer Banks transfers funds to the Merchant's account.

### Merchant Agent Server (MAS)

The MAS supports the Bank or Financial Institution's Acquiring Business and interfacing with the Merchants for transaction processing. It provides Merchant pre-registrations services, Bank or Financial Institution review and approval of Merchant requests for participation, Merchant registration services, Merchant administrative services and Merchant transaction processing.

### User Agent Server (UAS)

The UAS supports User participation in the electronic payment system. It provides User pre-registration services, bank or Financial Institution review and approval of user request for participation, User registration services and supports Mobile Stations in participating in the transaction process.

### Bank Gateway Server (BGS)

The BGS is the gateway to the Bank or Financial Institution's secure network. It interfaces with the Bank's Processor system to present transaction messages for approval form the Bank or Financial Institution and relays the responses to the MAS and UAS.

### Bank Processor System (BPS)

The BPS receives the transaction from the BGS and maps User mobile station number to an assigned bank account and also the merchant identifier to a bank account so that fund/credit availability can be checked and credit lines can be opened.

### Bank Issuer System (BIS)

The BIS validates the account information of Users and Merchants sent by the BPS for available credit/funds and opens credit lines to the merchants' accounts.

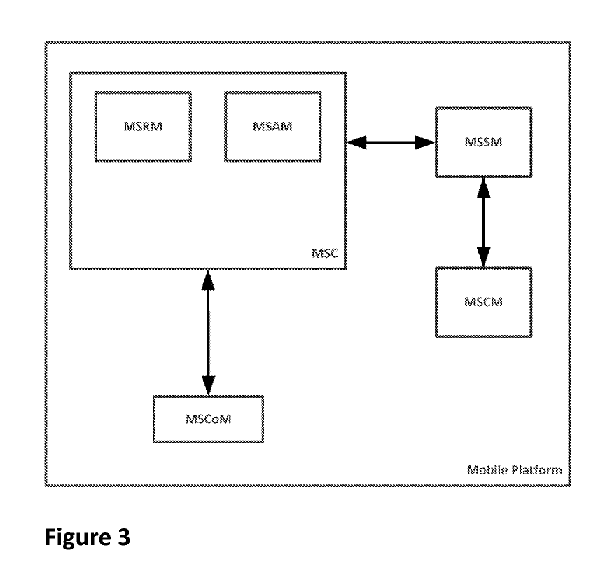

### FIG. 3

### Mobile Station User Application (MSUA)

The MSUA provides a user the means to participate in the electronic payment system proposed by the said invention. It provides the user interface to view and approve payment transactions, communicate with the User Agent Server (UAS) in a secure and reliable manner and view transaction and usage statistic reports.

### Mobile Station Controller (MSC)

The MSC provides the glue that orchestrates the User Application to assist a User participate in the electronic payment system. During setup of the User application it collects the IMEI/MEID number, the SIM (phone) number, and the local launch password and transmits it to the User Agent Server to initiate the generation of the digital security certificate which is stored in the key store by the Security Service.

The Control Service registers for ‘intents’ (events that raise platform notifications to the service) like SIM card change, device switched off, battery changed, not connected, aircraft mode and the like to run a health check during application start up.

The MSC ensures encryption all information exchange with the User Agent Server using the Cryptography and Communication services.

### Mobile Station Registration Module (MSRM)

The MSRM supports the MSC during the installation and setup of the User Application or after a mobile station change. It collects the key device parameters mentioned in the MSC, and relays it to the User Agent Server for verification and approval.

The Registration Module saves the said registration approval in the local store for verification with every use of the User Application.

### Mobile Station Authentication Module (MSAM)

The Authentication Module provides authentication of the User of the mobile station based on the local launch password. The Authentication Service also monitors the local launch password for expiry. A password is valid for a predefined period, configured in the User Application. The Authentication Service will warn the User about pending expiry of the local launch password and provide the user with a facility to change the password. In case the password has expired, the Authentication will coordinate with the MSC service to force the user to change the password as a prerequisite to launch the application.

The Authentication Service allows the user to change passwords on demand.

The Authentication Service switches to ‘panic’ mode in case the user enters incorrect password three times in succession. Succession count will be maintained across User Application restarts. When in ‘panic’ mode, the Authentication will work with the Logic & Control Service, the Messaging Service and the Communication Service to instruct the user Agent Server to invalidate the User's digital security certificate. The mobile station cannot participate in transactions unless a new certificate is installed.

### Mobile Station Security Module (MSSM)

As the name implies, the MSSM provisions all of the security needs of the User Application to protect the User from any kind of fraud. It manages the access to the digital security certificate (such as X509 Certificate) provided by the Bank or Financial Institution by maintaining a key store in the local storage. The Security Service controls all access to the key store where the digital security certificate is saved. The MSC, Cryptography and Communication services must request the Security Service to provide the digital security certificate.

### Mobile Station Cryptography Module (MSCM)

The MSCM provides encryption and decryption support for all messages exchanged with the User Agent Server. The MSCM also validates the User Agent Server by checking the digital security certificate sent by the User Agent Server.

The MSCM generates a digital signature for each transaction endorsement message sent to the User Agent Server. The digital signature is a means for non-repudiation of user's actions.

### Mobile Station Communication Module (MSCoM)

The MSCoM connects the User Application components to the network. It provides secure and reliable connections and can support TCP and HTTP(S) protocols. The User Application will only use HTTPS which uses SSL/TLS over TCP to provide encrypted information exchange.

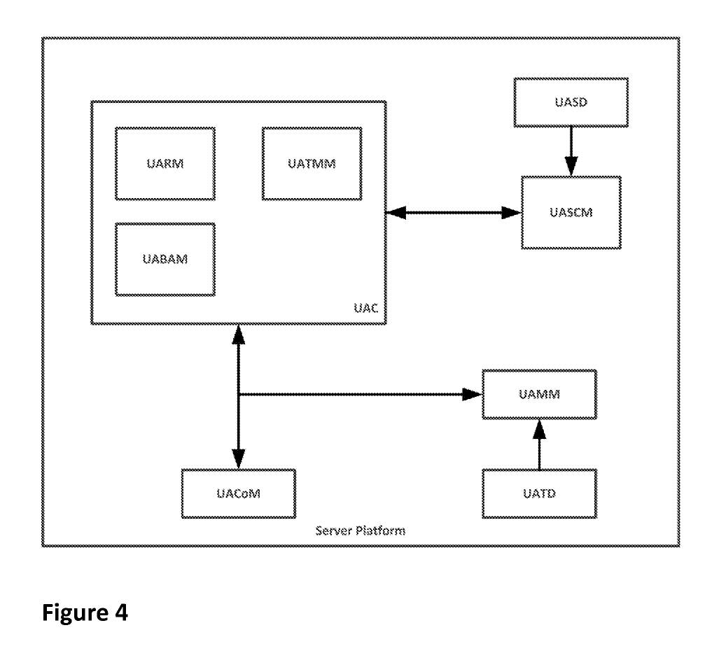

### FIG. 4

### User Agent Server (UAS)

The UAS supports Users' participation in the said invention to make electronic payments. It hosts web pages for users to sign up for on-boarding; it provides functionality for approved users to download and install the Mobile Station User Application; it interfaces with the Bank or Financial Institution's PKI System to request and deliver the electronic security certificate; it provides the functions to interact with Mobile Stations helping Users view and endorse payment transactions.

### User Agent Controller (UAC)

The UAC is the central module of the User Agent Server that controls and coordinates the actions of all other modules to provide various functions of the UAS. These include Bank or Financial Institution approval for User participation, Download of the User Application, Registration of the User Mobile Station, request and provide digital security certificate to the mobile station, managing User participation in electronic payment transactions and sundry functions like User Management, Reporting and Usage statistics.

The UAC contains the Registration Module (UARM) and the Bank Approval Module (UABAM). The UABAM manages the induction of new users (prospective customers) to capture user information and subsequent Bank or Financial Institute's approval for these requests and the user Agent Transaction Management Module (UATMM).

### User Agent Registration Module (UARM)

The UARM supports user on-boarding and registration. These are two separate phases that precede a User's participation in the electronic payment system.

On-boarding involves a user contacting the Bank or Financial Institution and indicating an interest in using the said invention for making electronic payments. Users do this by filling out a web form hosted by the UAS, providing information about themselves, their work and financial status, information about their mobile station that will be used for making electronic payments (inclusive of IMEI/MEID and assigned mobile phone number).

Registration phase begins after the User's participation request has been approved. After the User Agent Bank Approval Module (UABAM) generates and emails the link, the User can login to the UAS and download and install the Mobile Station User Application (MSUA). Upon completion of the installation of the MSUA, the User can participate in the electronic payment transactions.

### User Agent Bank Approval Module (UABAM)

The UABAM allows the Bank or Financial Institution's officials to view Users' request for participation, assess these applications and approve or reject these applications.

Approved applications are further processed by the UABAM allowing these users to logon to the UAS with their registered mobile stations to download and install the Mobile Station User Application (MSUA). The UABAM generates a user specific link (URL) and a one-time password which it emails to the User's registered email address. The User can then use that link to download and install the MSUA.

### User Agent Transaction Management Module (UATMM)

Electronic transactions requests like Payment, Authorize, Reversal and transaction responses like User endorsement, user denial, Bank approval and Bank denial require appropriate handling, which are managed by the UATMM. The UATMM works with the UAC and User Agent Messaging Module (UAMM) to retrieve messages from the Bank Gateway Server.

When a User connects to the User Agent Server, the UATMM receives the transaction from the UAMM to mark the status of the transaction and relays it to the User's mobile station. After the User endorsed/declined transaction message is received, the UATMM updates the status of the transaction (as User endorsed/declined) and forwards it to the Bank Gateway Server for further processing.

The UATMM maintains a queue for holding transaction messages so that each transaction message is sent separately tot eh User's mobile station and the corresponding status tracked independently. The downstream processing of a transaction processing is based on the status of the transaction as marked by the UATMM.

The UATMM prioritizes transaction messages sent to the User. When a payment transaction is being processed, the UATMM will down grade the priority of system generated messages (marketing fliers, reminders etc.) so these messages are sent to the User's mobile station after the completion of the transaction processing.

### User Agent Transaction Docket (UATD)

All components of the said invention interact by sending and receiving messages in a secure and reliable manner. Each component Server defines a transaction docket that is consistent with the messaging system followed by the said invention. The UATD defined by the UAS is comprised of the Merchant Agent Transaction Docket (MATD), the User's endorsement of the transaction and the digital signature generated by the Mobile Station User Application (MSUA).

### User Agent Messaging Module (UAMM)

The UAMM interfaces the User Agent Application with the Bank Gateway Server Message Broker (BGMB). The message broker is the channel though with the components of the said invention exchange transaction dockets. The UAMM transforms messages received from the mobile station into a UATD before sending it to the BGS; it converts a UATD received from the BGS into a format intelligible to the mobile station.

The Bank or Financial Institution may deploy several Bank Gateway Servers, in one or more geographical locations, each with a different instance of a Message Broker. The UAMM has the intelligence to locate the correct Bank Gateway Server (BGS) based on the User's registered phone number.

### User Agent Security Docket (UASD)

The UAS maintains two types of security dockets:

### Server Security Docket:

The Server Security Docket is comprised of an electronic security certificate (of the nature of X509 Certificate) provided by the Bank or Financial Institution and a unique identifier for the UAS assigned by the bank or Financial Institution's System Administrator. The UAS will present this security docket as its credential every time it connects to the Bank Gateway Server (BGS).

### User Security Docket:

Protection of User information at all times is the founding principle of the said invention. To ensure security of User information, the UAS defines a security docket for each registered User. The UASD is comprised of the User's registered mobile station's IMEI/MEID [International Mobile Equipment Identifier/Mobile Equipment Identifier], the User's mobile station phone number (identified by the Subscriber Identification Module (SIM)) and the User specific electronic security certificate provided by the Bank of Financial Institution. Included in the electronic security certificate is a Distinguished Name (DN) consisting of the User's name, geographic location, organization (optional) and email address.

### User Agent Security & Cryptography Module (UASCM)

Securing access and encrypting all data in transit are the basic to all components that comprise the said invention. To achieve this, the UAS works with security dockets (UASDs). The User Agent's Security Docket is generated and installed by the Bank or Financial Institution's System Administrator in the UAS.

For the User specific UASD, the UASCM interfaces with the Bank or Financial Institution's PKI System to request digital security certificate for the User during registration which is used to generate the UASD for the user. This UASD is installed in the mobile station during the installation and setup of the mobile station.

The UASCM interfaces with the Bank or Financial Institute's PKI system to validate UASD when a User mobile station connects with the UAS.

The UASCM maintains a secure key store where it stores the digital security certificate generated by the PKI System for the User Agent Server. This certificate is used to provide the User Agent Server's credentials while connecting with the User mobile stations and the Bank Gateway Server.

The UASCM encrypts all messages it send and decrypts all messages it receives using the corresponding cryptographic keys stored in its key store.

### User Agent Communication Module (UACoM)

The UACoM connects the User Agent Server (UAS) components to the network. It provides secure and reliable connections and can support TCP and HTTP(S) protocols. The UAS will only use HTTPS which uses SSL/TLS over TCP to provide encrypted information exchange.

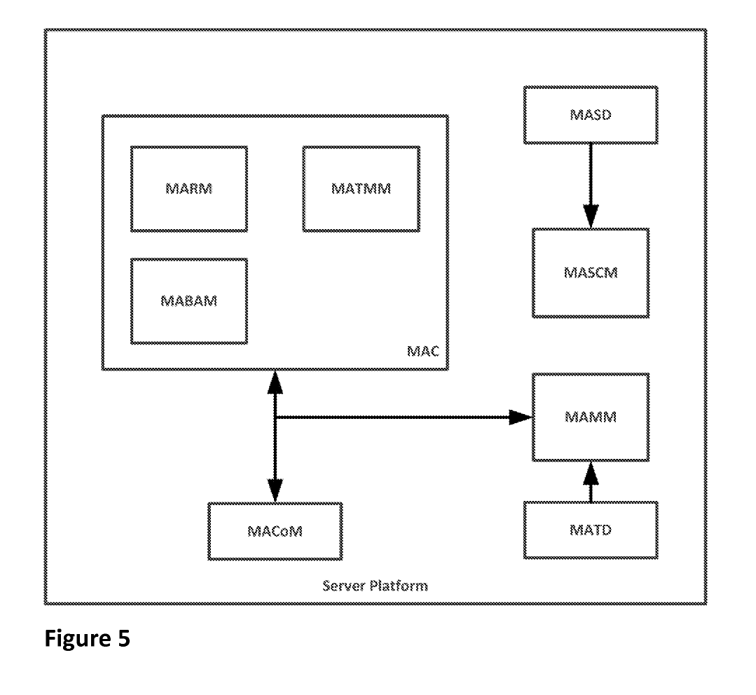

### FIG. 5

### Merchant Agent Server (MAS)

The MAS supports Merchants' participation in the said invention to initiate requests for electronic payments. It hosts web pages for Merchants to sign up for on-boarding; it provides functionality for approved Merchants to download and install the electronic security certificates; it interfaces with the Bank or Financial Institution's PKI System to request and deliver the electronic security certificate; it provides the functions Merchant Organization to manage their organization structure; it allows Merchant Organization managerial staff to manage merchant representatives who work for POS terminals; it provides Internet browser based support for POS agents to initiate transactions, view status of transactions and generate operational reports. The merchant agent server is constituted by:

### Merchant Agent Controller (MAC)

The MAC is the central module of the Merchant Agent System that control and coordinates the actions of all other modules to provide various functions of the MAS. These include Bank or Financial Institution approval of Merchant participation requests, Managing Merchant Organization Units, registration of the Merchant Representatives, managing Merchant Representatives, request and provide digital security certificate to the Merchant Representatives, managing Merchant Organization participation in electronic payment transactions and sundry functions like Reporting and Usage statistics.

The MAC contains the Registration Module (MARM) and the Bank Approval Module (MABAM). The MABAM manages the induction of new Merchants (prospective merchants who will post payment requests) to capture Merchant information and subsequent Bank or Financial Institute's approval for these requests. An approved Merchant will be allocated a Bank Account and a unique identifier. The unique identifier will be used to identify the Merchant Organization and the Bank Account will receive all credit lines opened during payment transactions.

The MARM controls the registration of a Merchant Organization POS station. This includes generation of the Merchant Representative specific digital security certificate and completing the registration by send an appropriate status to the Merchant Representative's email address.

### Merchant Agent Registration Module (MARM)

The MARM supports Merchant on-boarding and registration. These are two separate phases that precede a Merchant's participation in the electronic payment system.

On-boarding involves a merchant contacting the Bank or Financial Institution and indicating an interest in using the said invention for initiating electronic payments. Merchants do this by filling out a web form hosted by the MAS, providing information about their organizations, their business and financial status. The Bank or Financial Institution reviews the application based on criteria dictated by the Bank or Financial Institution's Acquirer practice. The Merchant Organization and the Bank or Financial Institution agree on a discount rate that will apply to transactions posted from the Merchant Organization; the Merchant Organization is provided a Bank Account where the credit lines will be opened after each transaction is approved by the Bank or Financial Institution.

The MARM generates a unique identifier for the Merchant Organization after the Bank or Financial Institution has approved the participation request. This unique identifier is included in each of the electronic security certificate provided to the merchant Organization representatives. The MARM allows Merchant Organization relationship administrator to manage the organization structure of the Merchant Organization by adding/modifying/removing organization units from where payment transactions will be initiated. The MARM also allows the relationship administrator the facility to add/modify/delete Merchant Representatives who will initiate payment transactions.

After a merchant representative is added, the MARM will generate a link (URL) and a one-time password and send an email to the merchant representative's registered email account. The merchant representative can use the URL to login to the MAS and download and install the electronic security certificate generate for the merchant representative.

### Merchant Agent Bank Approval Module (MABAM)

The MABAM allows the Bank or Financial Institution's officials to view Merchants' requests for participation, assess these applications and approve or reject these applications.

Approved applications are further processed by the MABAM allowing the Merchant relationship manager to logon to the MAS and begin administering the MAS for merchant participation. Administration tasks involve adding/modifying/deleting Organization Units and merchant representatives in each of the Organization Units.

After approval from the Bank or Financial Institution, the MABAM will use the MARM to generate a link (URL) and a one-time password for the relationship manager to access the MAS. The relationship manager can use the URL to logon to the MAS and download and save the electronic security certificate. Upon installation of the electronic security certificate, the relationship manager can being administrative activities.

### Merchant Agent Transaction Management Module (MATMM)

Electronic transactions requests like Payment, Authorize, Reversal and transaction responses like User endorsement, user denial, Bank approval and Bank denial require appropriate handling, which are managed by the MATMM. The MATMM works with the MAC and Merchant Agent Messaging Module (MAMM) to retrieve messages from the Bank Gateway Server.

When a Merchant Representative connects to the Merchant Agent Server, the MATMM receives the transaction from the MAMM to mark the status of the transaction and relays it to the Bank Gateway Server. After the User endorsed/declined transaction message is received, the MATMM updates the status of the transaction (as User endorsed/declined) and again forwards it to the Bank Gateway Server for further processing.

The MATMM maintains a queue for holding transaction messages so that each transaction message is sent separately to the Merchant Representative's web browser. In the case of the Merchant e-commerce web site or ATM Machine, the MATMM will consolidate all messages received and transfer then to after the transaction processing has completed.

### Merchant Agent Transaction Docket (MATD)

All components of the said invention interact by sending and receiving messages in a secure and reliable manner. Each component Server defines a transaction docket that is consistent with the messaging system followed by the said invention. The MATD defined by the MAS comprises of the invoice for the purchase, the currency of purchase and a time-out period for the MATD and the digital signature generated by the Merchant Agent security and Cryptography Module (MSCM).

### Merchant Agent Messaging Module (MAMM)

The MAMM interfaces the Merchant Agent Server with the Bank Gateway Server message broker. The message broker dictates the format of the messages that it will send and receive. The MAMM transforms all messages to comply with the messaging standards of the message broker.

The Bank or Financial Institution may deploy several Bank Gateway Servers, each with a different instance of a Message Broker. The MAMM uses an internal mechanism to locate the correct Bank Gateway Server based on the User's registered phone number.

### Merchant Agent Security Docket (MASD)

The MAS maintains two types of security dockets:

### Server Security Docket:

The Server Security Docket is comprised of an electronic security certificate (of the nature of X509 Certificate) provided by the Bank or Financial Institution and a unique identifier for the MAS assigned by the Bank or Financial Institution's System Administrator. The MAS will present this security docket as its credential every time it connects to the Bank Gateway Server (BGS).

### Merchant Representative Security Docket:

Protection of merchant information at all times is the founding principle of the said invention. To ensure security of merchant information, MAS defines a security docket for each registered merchant representative. The MASD is comprised of the merchant representative specific electronic security certificate provided by the Bank of Financial Institution. Included in the electronic security certificate is a Distinguished Name (DN) consisting of the merchant representative's name, geographic location, organization unit and email address.

### Merchant Agent Security & Cryptography Module (MASCM)

Securing access and encrypting all data in transit are the basis elements of all services provided by the Merchant Agent Server. The MASCM interfaces with the Bank or Financial Institution's PKI System to request digital security certificate for the Merchant Representatives. The MASCM provides Merchant representative specific information to the PKI System to generate a unique Distinguished Name (DN) for the Merchant representative. This DN is used to identify the user during all subsequent interactions with the POS web browser.

The MASCM interfaces with the Bank or Financial Institute's PKI system to validate a digital security certificate when a POS web browser presents when connecting with the Merchant Agent Server.

The MASCM maintains a secure key store where it stores the digital security certificate generated by the PKI System for the Merchant Agent Server. This certificate is used to provide the Merchant Agent Server's credentials while connecting with the POS web browsers and the Bank Gateway Server.

The MASCM encrypts all messages it send and decrypts all messages it receives using the corresponding cryptographic keys stored in its key store.

### Merchant Agent Communication Module (MACoM)

The MACoM connects the Merchant Agent Server (MAS) components to the network. It provides secure and reliable connections and can support TCP and HTTP(S) protocols. The MAS will only use HTTPS which uses SSL/TLS over TCP to provide encrypted information exchange.

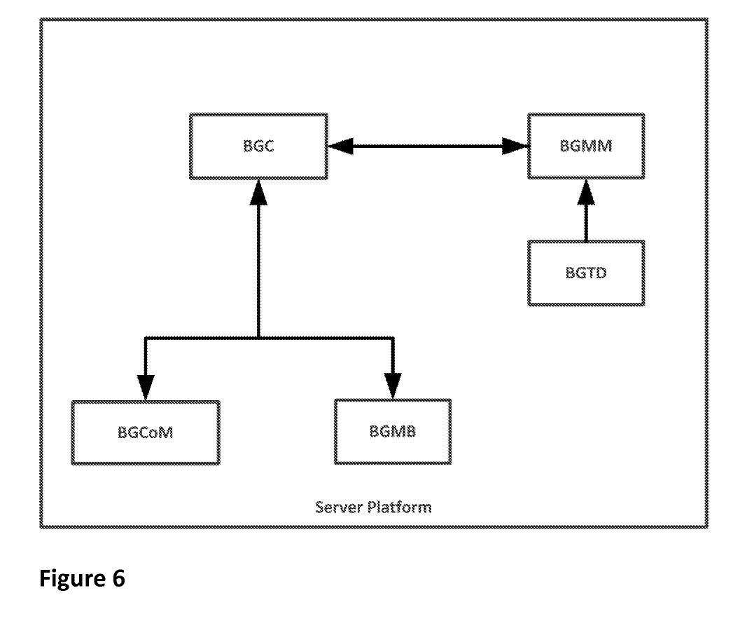

### FIG. 6

### The Bank Gateway Server (BGS)

The BGS is the meeting point for all messages exchanged between all participating servers (UAS, MAS and Bank Processor). It hosts the various request and response message channels, providing an environment for secure and reliable delivery of messages. The BGS does not persist any information about the Users, Merchants or the transactions.

### Bank Gateway Controller (BGC)

The BGC hosts the message brokers and mediates transaction message exchanges between the Merchant Agent Server, the User Agent Server and the Bank or Financial Institution's Processor (or Acquirer System). The BGC is the traffic controller for the transaction messages. It monitors the various message channels opened by the Bank Gateway Message Broker (BGMB) to prevent message flooding. It moves undelivered messages to backup storage to ease off traffic in message channels. The BGC works with the Bank Gateway Messaging Module (BGMM) to collect messages that have timed out in the message channels to remove them from the channels and generate appropriate status response messages to the senders.

### Bank Gateway Message Broker (BGMB)

The BGMB provides message channels for message senders and message receivers (Merchant Agent Application, User Agent Application, Bank Processor) to exchange messages in a secure and reliable manner. For each transaction type (Payment, Authorize, Reversal, Query and System) the BGMB arranges a separate message channel: one channel for requests and another for response. Message produces send requests to the corresponding message channel based on the message type of the request. Consumers (Merchant Agent Application, User Agent Application, Bank Processor) register with the BGMB for particular message types and are notified when a message of interest arrives at the message channel.

### Bank Gateway Transaction Docket (BGTD)

The BGS provides the interface for the MAS and UAS to interact with the Bank or Financial Institution's Processor system. The Bank's Processor has components that wait for specific messages posted for it to process. These message types are encapsulated in the BGTD. The BGTD provides a wrapper for the User endorsed MATD; the wrapper contains information that identifies a specific BGS, which can be used by the Bank's Processor to validate the received message. The wrapper also contains a priority indicator for out-of-band processing, during exception handling. Priority is required to control transaction report requests, marketing flyers and similar management messages.

### Bank Gateway Messaging Module (BGMM)

The BGMM provides mechanisms to send, receive and transform messages. Messages are identified by the transaction types. Electronic payment transactions are further filtered by the phone number of the User. Payment transaction messages are delivered to receivers only when they subscribe for messages filtered by the User's mobile phone number. Each message has a specified time-out period. If a message is not delivered to any said receiver within this period, the BGMM provides a special handler for timed out messages. This handler removes the messages from the message channel, creates an appropriate message for a said sender and places that message in the response message channel. Timed out messages are also notified to the System Administrator, to help the Administrator in tracking phantom transactions or fraud monitoring.

### Best Method of Executing the Invention

The said invention achieves its functions by exchanging messages in a secure and reliable manner between the Merchant Agent Server (MAS), User Agent Server (UAS), Bank Gateway Server (BGS) and the Bank Processor & Bank Issuer Systems. These servers collaborate to provide the necessary functionality to implement a reliable and fraud-free electronic payment system. Users, Merchants and the Bank or Financial Institution come together to participate in the electronic payment system and their coming together is best described in phases of interaction—Pre-registration, Registration and Transaction phases, which are described below.

It is important to bear in mind that all Servers—the User Agent Server, the Merchant Agent Server and the Bank Gateway Server provide environments that support execution of multiple transactions in parallel; that is the server platforms support multi-threading. The Bank or Financial Institution may deploy several instances of each server in geographically dispersed locations.

### Phase I: Pre-Registration or On-Boarding Phase

The engagement of Users and Merchant with the Bank or Financial Institution begins with an expression of intent to participate in the electronic payment system. The User Agent Server (UAS) and the Merchant Agent Server (MAS) support Users and Merchants with the pre-registration activities.

### User Pre-Registration

The structure of the User Agent Server (UAS) is depicted in FIG. 4. The UARM provides the web form for users to fill out and defines the information that is captured. The UABAM helps the Bank or Financial Institute officers to review and approve/reject user applications. Applications approved by the Bank or Financial Institution are progressed to the Registration phase.

### Merchant Pre-Registration

The structure of the Merchant Agent server (MAS) is depicted in FIG. 5 and the components modules are described in page Y. The MARM provides the web form for merchants to fill out and defines the information that is captured. The MABAM helps the Bank or Financial Institute officers to review and approve/reject the merchant applications. Applications approved by the Bank or Financial Institute are progressed to the Registration phase.

### Phase II: Registration Phase

With the Registration phase, the engagement of the Users and Merchants with the electronic payment system begins in earnest. Both User and Merchants must go through a different set of activities in preparation of participation in the payment transactions.

### User Registration

The User receives an email from the UAS (FIG. 4) which contains a user specific URL and a one-time password to access the UAS with the registered mobile station. The User uses the Internet browser in the mobile station to access this URL. After validating the one-time password, the UAS allows the User to download the MSUA shown in FIG. 3. The MUSA starts setup and installation as soon as download is completed. After installation and setup is completed, the MSUA starts and prompts the User to enter the MSUA launch password. The password is hashed by the MSCM and stored in the Mobile Station. The MSRM then runs to collect the IMEI/MEID number and the mobile phone number. The MSRM works with the MSC, MSSM and MSCoM to connect with the UAS and sends the MSSD. The UAS verifies the MSSD with the registration information originally provided by the User and sends success or failure status. A success is recorded by the MSUA while a failure status will start uninstalling the MSUA and erase all saved data. The mobile station is now ready for participation in payment transactions.

### Merchant Registration

The MAS (FIG. 5) supports the registration of Merchant representatives. Merchant representatives can access the MAS with an Internet browser (running on any computer—desktop, laptop or tablet). The Merchant relationship manager (contact person) indicated during pre-registration receives an email with a user specific URL and a one-time password to access the MAS. After the MSA validates the password, the MASCM works with the Bank or Financial Institution PKI System to generate an electronic security certificate (of the nature of X509 certificate) which is downloaded and stored in the Merchant representative's browser.

The Merchant Relationship Manager can now login and setup Merchant Organization structure and add merchant representatives who man the POS stations. The MARM follows similar steps as for the relationship manager to include each Merchant representative. Merchant representatives can now login from their computers, again using Internet browsers, to download the electronic security certificate. The Merchant Organization is ready to participate in payment transactions.

### Phase III: Payment Transactions Phase

The said invention achieves its functions by securely exchanging messages between the MAS, UAS BGS, Bank Processor and Bank Issuer Systems. FIG. 2 illustrates a typical Network topology for executing the said invention.

It is important to bear in mind that all Servers—the UAS, the MAS and the BGS are hosted in environments that support execution of multiple transactions in parallel; that the server platforms support multi-threading. These Servers can be deployed in multiple locations, geologically dispersed across the Globe.

### Purchase Transaction—Phase I: Merchant Initiates Purchase Transaction

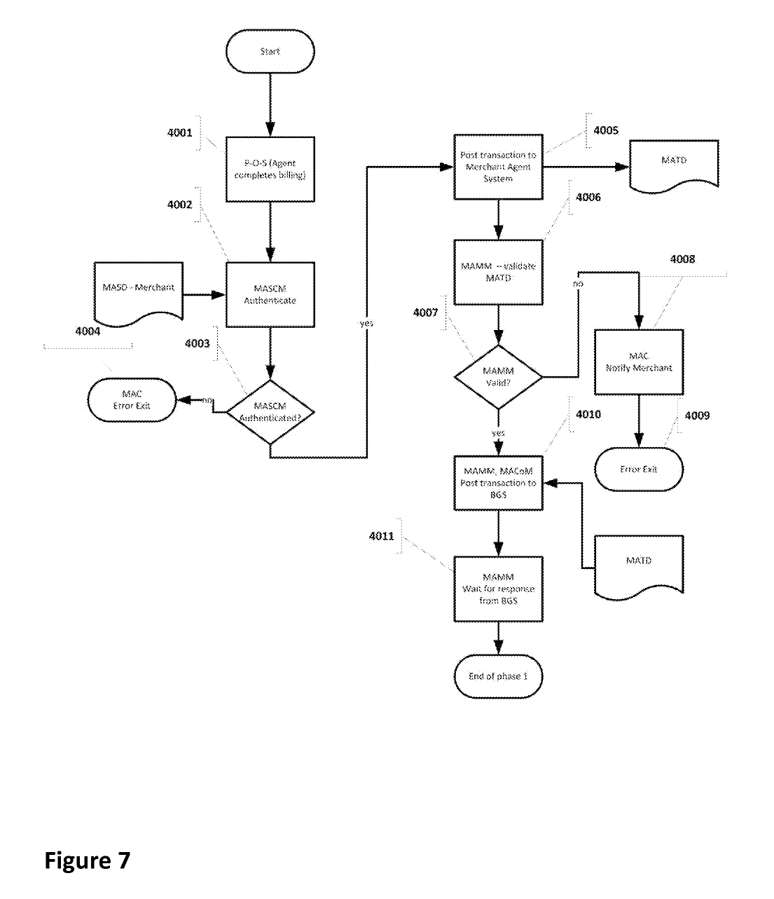

Phase I relates to functions executing in the MAS (FIG. 2) internally organized as shown in FIG. 5. FIG. 7 depicts the transaction flow at POS Station. After completing the billing the Merchant representative connects to the MAS using an Internet browser (4001 in FIG. 7), presenting the MASD of the Merchant representative. After authentication by the MASCM (4002-4005 in FIG. 7) the MAS displays the transaction posting screen where the Merchant representative enters the invoice details, the currency of transaction, the timeout period for the transaction (timeout period before which the User must view and endorse the transaction). The MAC uses the MAMM to validate the MATD received (4006 in FIG. 7) by verifying the digital signature in the MATD and posts the MATD to the BGS using the MACoM (4010 in FIG. 7).

The MAS connects to the BGS using the MASD for the MAS, which includes a distinct digital security certificate create by the Bank or Financial Institution's PKI System. After posting the MATD to the BGS the MAMM awaits a response from the User (4011 in FIG. 7). The Internet browser in the Merchant representative's POS station reflects this status.

### Purchase Transaction—Phase II: Card Owner Views and Approves Transaction

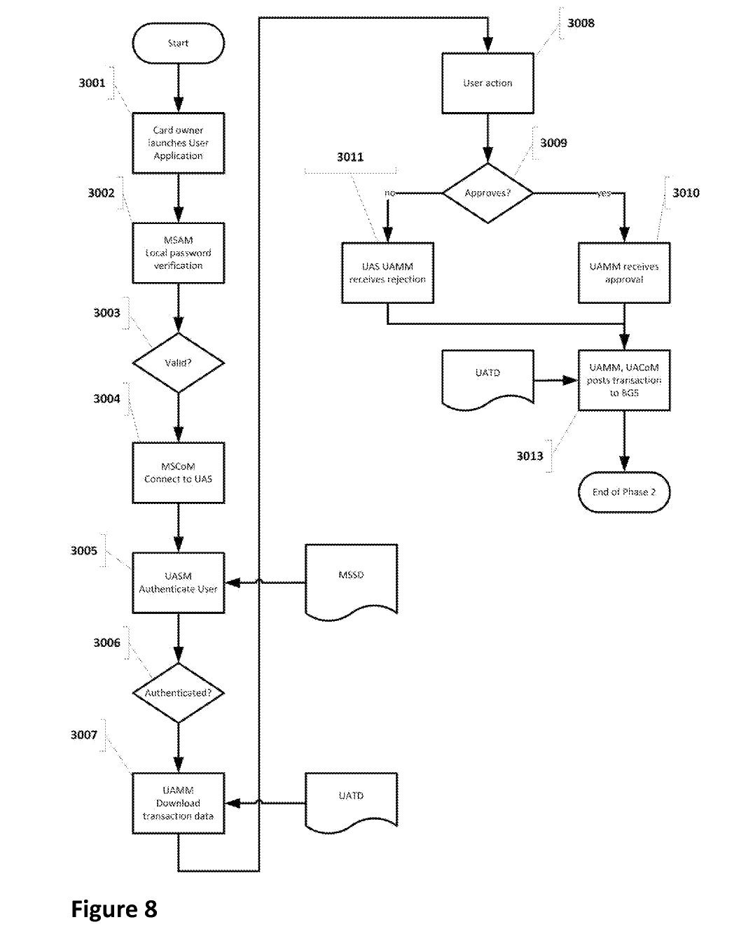

Having posted the transaction to the MAS, the merchant asks the User to endorse the transaction. The flow of the purchase transaction is depicted in FIG. 8. When the User launches the MSUA (FIG. 3), the MSAM prompts the User for the local launch password. The MSAM verifies the entered password and if found correct (3001-3003 in FIG. 8), creates a MSSD (FIG. 3) to connect to the UAS (FIG. 4).

The UASM (FIG. 4) uses the MSSD to authenticate the User (3004-3006 in FIG. 8). If the MSSD is found to be correct, the UAS connects with the BGS using the UASD for the Server to fetch the MATD posted by the Merchant representative (3007 in FIG. 8), using the User's mobile number as the message identifier. The MATD is sent to the MSUA for display to the User and capture of User endorsement (3008-3009 in FIG. 8). After the User endorses the purchase transaction, the MSMM enhances the UATD (FIG. 3) with the User's approval (or denial) and sends the enhanced UATD to the UAS using the MSCoM (3012 in FIG. 8).

The UAMM receives the UATD, connects to the BGS to direct the UATD to the MAS (the MAS is waiting for this message at the BGS). Endorsement from the User completes this phase of the transaction.

### Purchase Transaction—Phase III: User Approved Transaction is Processed for Clearing

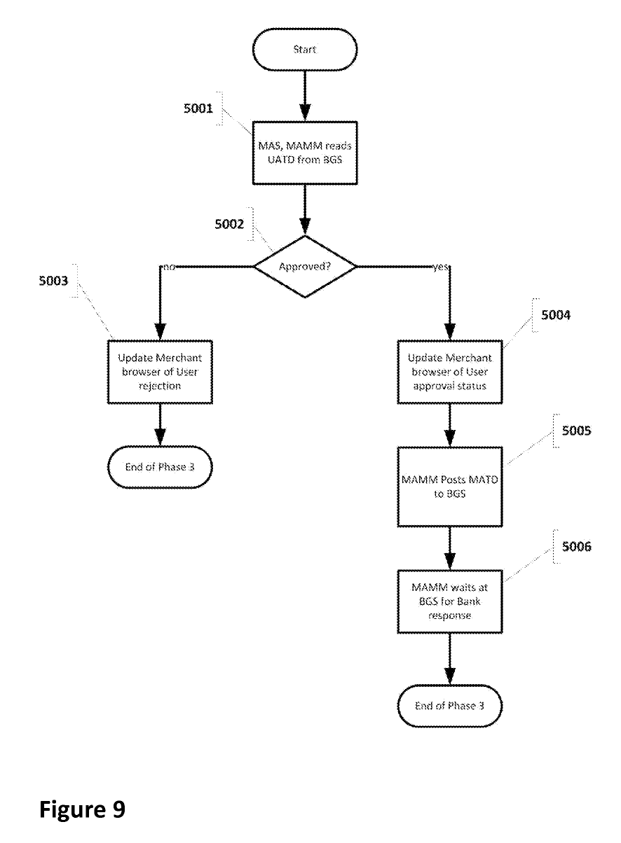

The MAS after receiving the UATD (5001 in FIG. 9), verifies the UATD using the MAMM and checks if the User has endorsed the transaction (5002 in FIG. 9). The MAS updates the Merchant representative's browser with the User's endorsement (5004 in FIG. 9) or User's rejection (5003 in FIG. 9). The MAMM then generates an enhanced MATD, connects to the BGS and posts a message for the Bank or Financial Institution's Processor System (5005 in FIG. 9). The BGMM (FIG. 6) in the BGS has components always waiting on messages for the Bank's Processor system. The BGMM relays the MATD posted by the MAS to the Bank's Processor using the BGCoM. The BGS waits for a response from the Bank's Processor (5006 in FIG. 9).

### Purchase Transaction—Phase IV: Bank or Financial Institution Processor Processes Request

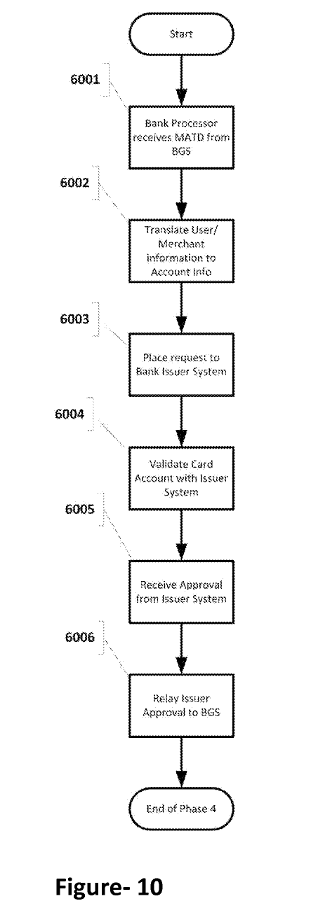

The Bank or Financial Institution's Processor System is responsible for receiving payment requests, transforming the messages and place the transaction for approval to the Bank or Financial Institution's Issuer System. This flow is illustrated in FIG. 10.

The Bank's Processor system receives the MATD from the BGS (6001 in FIG. 10). The MATD contains User credentials, Merchant credentials, invoice details, and User endorsement. The Bank's Processor System translates the User's mobile phone number to a Bank Account by looking up a database. The MATD is enhanced with the Bank Account Number (6002 in FIG. 10) that is assigned to the User. The Bank's Processor then places the Payment Transaction request with the Banks' Issuer System (6003 in FIG. 10).

The Bank's Processor enhances the MATD with the Merchant's assigned Account Number (where funds from the User's account will be credited). The Bank's Issuer System looks up the provided Account Number and the invoice to determine whether credit is available (for Credit Transactions) or funds are available (for Debit card transactions) (6004 in FIG. 10). The Bank's Issuer System enhances the received Purchase Transaction message with its response (approval or decline) and sends the response to the Bank's Processor (6005 in FIG. 10). The Bank's Processor System removes the User and Merchant Account Information from the MATD and sends the Bank's Issuer response to the Bank Gateway System (6006 in FIG. 10).

Purchase Transaction—Phase V: The MAS & UAS Process Approval from Bank Issuer System

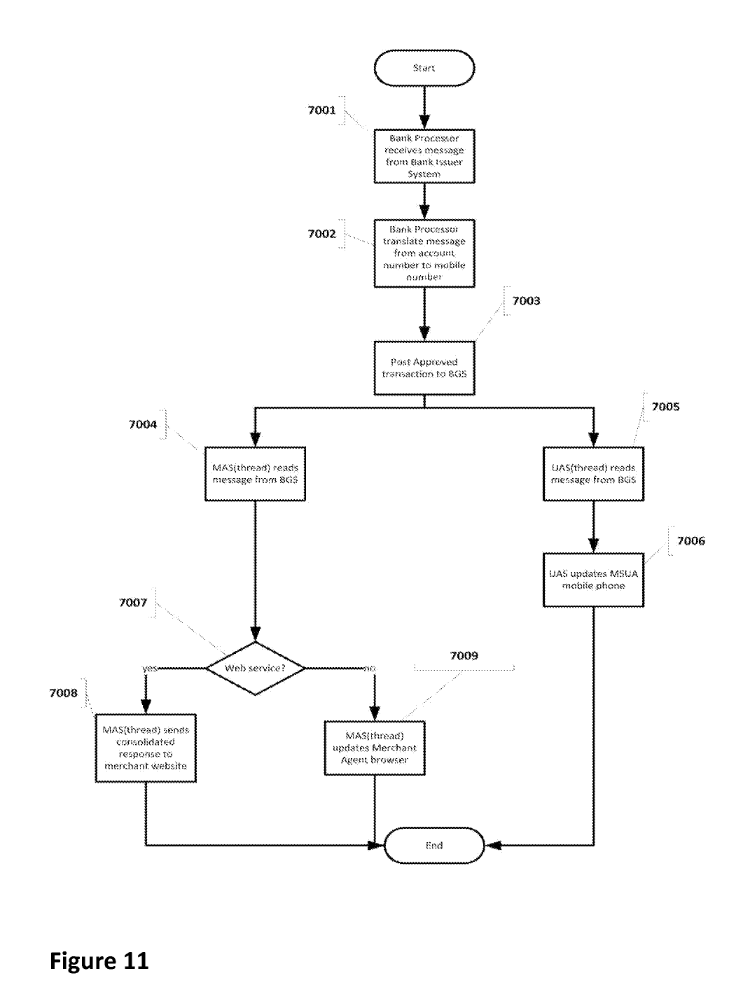

The final phase of the processing of a Payment Transaction is depicted in FIG. 11. The Bank's Processor System receives the approval from the Bank's Issuer System and initiates the response cycle by posting the response to the BGS (7001 in FIG. 11). The Bank's Processor System strips off the Bank Account information from the MATD (7002 in FIG. 11) (for these are not required) and posts the message to the BGS (7003 in FIG. 11). The BGS receives the response from the Bank Processor System and posts the responses for the MAS thread (7004 in FIG. 11) and the UAS thread (7005 in FIG. 11). The UAS thread updates the MSUA with the completion status of the Purchase transaction (7006 in FIG. 11). The MAS thread updates the merchant's browser (7009 in FIG. 11).

### Alternate Implementations

### Embodiments

The MAS supports two alternative methods of executing payment transactions—For e-commerce web sites and ATM machines. In both these cases, the User initiates the transaction.

### E-Commerce Web Site:

A transaction can be posted from an e-commerce web site which is authored by the Merchant establishment. To service e-commerce web site, the MAS provides a web service with a published API. The following events take place while posting a transaction from an e-commerce web site:
User checks out the shopping cart after completing shopping
Web site displays invoice and a link to initiate payment with the said invention
User navigates to the link for said invention; e-commerce web site displays invoice details and a web form for user mobile phone number and transaction timeout period (configured timeout period=30 seconds)
User enters his/her mobile phone number and optionally a new timeout period
E-commerce web page connects to the MAS presenting the Merchant-MASD for authentication by the MAS and posts the MATD to the MAS

The remaining phases (Phase II to Phase V) of the payment transaction are identical to that described for a POS station; in the case of the e-commerce web site, the MAS consolidates all responses (User endorsement and Bank Issuer approval) and sends it to the merchant e-commerce web site's web service client (7008 in FIG. 11)

### ATM Machine:

Any of the Bank or Financial Institution's ATM machine may also be programmed to work with the said invention. The following events take place while withdrawing cash from an ATM machine:
The ATM machine displays a form to enter the amount of cash to be served, the user's mobile phone number and (optionally) the timeout period.
The ATM machine connects to the MAS web service through a TLS/SSL connection presenting Merchant-MASD for authentication by the MAS and posts the MATD

The remaining phases (Phase II to Phase V) of the payment transaction are identical to that described for a POS station; in the case of the e-commerce web site, the MAS consolidates all responses (User endorsement and Bank Issuer approval) and sends it to the merchant e-commerce web site's web service client (7008 in FIG. 11).

We claim:

1. A simple, secure and efficient computer based system that enables electronic payments with smart mobile stations, without the risk of any fraud, comprising: a server with intelligent software that facilitates merchants to place transaction requests, a server with intelligent software which facilitates retrieval of payment transactions using a user's mobile number as an identifier for the transaction and a server which provides a gateway to a bank or financial institution's network, wherein:
a mobile device registered by a user to view and endorse transaction requests raised by merchants,
a server with intelligent software which interfaces with bank or financial institution's network for the approval of the user endorsed transactions based on a plurality of financial products in support of credit or debit based transactions, and
the identity of the said user accounts never being used in public networks and/or systems during any payment transaction instead of which the user's mobile phone number being the identification mechanism for each payment transaction.

2. Said system which facilitates a merchant to use a plurality of devices including but not limited to an Internet browser running in a desktop, laptop or any mobile device or POS station or an intelligent software installed in the said devices, to place a payment transaction by using the user's mobile number as an identifier for routing and processing the payment transaction request.

3. A system within the system in claim 1, which facilitates the retrieval and endorsement of the payment transaction request raised by a merchant by an authenticated user requesting to view the payment transaction, using the user's mobile number as a means of identifying the transaction and subsequently endorsing the payment transaction.

4. A system within the system in claim 1, wherein user with a smart mobile device can view and endorse payment transactions after successful authentication.

5. A system within the system in claim 1, wherein a payment transaction expressly endorsed by a user is routed to the bank or financial institution network for approval while unendorsed transactions are not routed to the bank or financial institution's network and managing any unattended payment transaction requests by generating an appropriate response to the corresponding requestor.

6. A transaction management system to orchestrate the said fraud free mobile electronic transaction system that obviates the need for use any artifact such as but not limited to a credit/debit card by the user and consequently obviates the need for use of traditional a point of sale device by the merchant thereby ensuring that no third party has access to sensitive personal information of the user nor is there a transmission of the same through between third parties and eliminating any opportunity for fraudsters to gain and use such sensitive information.

7. A method of the system in claim 6, wherein a merchant or merchant representative:
uses an internet browser or a device installed with intelligent software to interface with the said system, and
is authenticated using a digital certificate of the nature of, but not restricted to, a X509 certificate, issued by the bank or financial institution with specific trust establishment.

8. A method of the system in claim 6, wherein the merchant:
posts an abstracted payment transaction request comprised of an invoice, a digital signature ascribable to the requestor and a timeout period for the payment transaction, to a request queue,
the posted payment transaction bearing the user's mobile number as a transaction identifier or selector property, and
having posted the request, awaits User endorsement in an appropriate response queue.

9. A method of the system in claim 6, wherein:
the posted payment transaction is retrieved from the request queue using the user's mobile number as the message selector, and
after the user with a registered mobile device has been successfully authenticated the abstracted payment transaction being appropriately transformed for viewing in the USER'S mobile device.

10. A method of the system in claim 6, wherein:
the user endorses or rejects the payment transaction in view in the mobile device,
the user endorsed transaction being appropriately transformed for further processing,
the merchant being informed about the endorsement status of the requested payment transaction,
posting the endorsed payment transaction in an appropriate queue for approval from the bank or financial institution, and
completing or aborting the transaction in event of user rejection or the payment transaction request timing out.

11. A method of the system in claim 8, wherein:
the user endorsed payment transaction is received and validated,
payment transaction with ‘endorsed’ status are routed to an appropriate queue for approval from the bank or financial institution,
payment transaction with ‘rejected’ or timed out′ status is aborted, and
the merchant and user being notified about the status of the payment transaction.

12. A method within the system in claim 6, wherein:
the user endorsed transaction is posted to the bank or financial institution's network, and
the response from the bank or financial institution's network is received and placed in the appropriate queue with the user's mobile phone number as a message selector property.

13. A method within the system in claim 6, wherein:
the merchant is updated with the status of the bank or financial institution's response to the payment transaction request, and
appropriate action being taken to close the payment transaction.

14. A method within the system in claim 6, wherein:
the user is updated with the status of the bank or financial institution's response to the payment transaction request, and
appropriate action being taken to close the payment transaction.

15. A robust registration process, to register merchants and users to participate in the said fraud free electronic payment transaction system that ensures no personal or financial information about merchants or users are captured, stored or transmitted during the payment transaction process with the help of an elaborate registration process facilitating accurate identification, authentication and authorization of merchants, users and user mobile devices, mitigating the risk of exposure due to mobile phone cloning or loss.

16. A method in the system in claim 15, wherein:
a merchant can request for registration and participation in the said electronic payment transaction processing system,
a bank or financial institution can review and approve the merchant's registration request,
a successfully registered merchant is issued a digital certificate, of the nature of, but not limited to a X509 certificate, with a specific trust established with the bank or financial institution's Public-Key-Cryptography Infrastructure (PKI), and
the digital certificate includes a globally unique identifier for the merchant organization.

17. A method in the system of claim 15, wherein:
the merchant organization may register additional representatives who operate the point-of-sale stations, during a digital certificate for the merchant representative is issued, and the unique identifiers and digital certificates being used for authenticating the merchant organization and merchant representative while posting transaction requests.

18. A method in the system of claim 15 wherein:
the user can request for registration and participation in the said electronic payment transaction processing system,
a bank or financial institution can review and approve the merchant's registration request,
capture the mobile device IMEI/ESN/MEID number and the user's International Subscriber Number (ISN) or International Mobile Subscriber Identity (IMSI), and
a successfully registered merchant is issued a digital certificate, of the nature of, but not limited to a X509 certificate, with a specific trust established with the bank or financial institution's Public-Key-Cryptography Infrastructure (PKI).

19. A method in the System in claim 15, wherein:
a successfully registered user receives, in the registered email id, a link to download and install the mobile device application along with a one-time use password,
a requesting user is authenticated with the one-time use password and allowed to download the mobile device application software,
verification that the requesting mobile device bears the registered IMEI/ISN/MEID number, and the registered ISN/IMSI, and
downloading and installing the digital certificate generated for the specific user by the bank or financial institution's PKI system.

20. A method in the system in claim 15, wherein,
the user is prompted, on installation and during setup, to provide the launch password which must be conformant with password rules set by the bank or financial institution.

21. The system in claim 6 necessitating the authentication and authorization process receives the key parameters from the mobile station—IMEI/MEID/ESN, ISN/IMSI (phone) number and launch password along with the issued digital certificate for establishing connection with the said system, and renders a cloned smart mobile station unusable for participation in the said electronic payment processing system.

22. The system in claim 6 necessitating the a launch password before launching the application in the mobile station provides a deterrent when a user's mobile station is lost or misplaced, with three failures to provide the correct password causing the invalidation of the digital certificate in the mobile station and thereby rendering the smart mobile station unusable for participation in the said electronic payment processing system.
